(19) United States
(12) Patent Application Publication
(10) Pub. No.: US 2009/0206640 A1
(43) Pub. Date: Aug. 20, 2009

(54) Hidden-type automobile child safety seat assembly

(76) Inventor: Liang-Chin Chen, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,294

(22) Filed: Feb. 20, 2008

(51) Int. Cl. B60N 2/26

(52) U.S. Cl. 297/216.11

(57) ABSTRACT

A hidden-type automobile child safety seat assembly has three types of safety seats respectively mounted in different portions of the rear bench of a passenger car and includes: one first safety seat, one second safety seat and one third safety seat. The first seating portion is pivotally connected to the bottom of the rear bench. The second safety seat comprises a second seating portion, and a protective bar. The second seating portion and the protective bar are pivotally connected to the back of the rear bench. The third safety seat comprises a third seating portion. The third seating portion is pivotally connected to the back of the rear bench. With this arrangement, it is not necessary to spend time and labor to install the child safety seat. Therefore, it is very convenient to use this inventive child safety seat.

### BACKGROUND OF THE INVENTION

1. Field of the Invention

The present invention is related to a hidden-type automobile child safety seat assembly, and in particular to a child safety seat assembly hidden in the rear bench of a car.

2. Description of Related Art

Passenger cars are among the most popular means of transport for most families with children. According to the current requirements for carrying children in a car, it is necessary to install a child safety seat on the rear bench of the car and fasten a five-point safety belt to the children in order to protect the children seated in the car.

For people who drive a car to work on weekdays, the rear bench of the car may be spared for clients or colleagues in business, and thus the child safety seat needs to be removed. However, on the weekend, in order to take the child to the outside, it is necessary to install the child safety seat again on the rear bench of the car and put the child on the safety seat. Since the current child safety seat available in the market has a certain volume, it occupies space after being installed on the rear bench of the car. Further, the process for installing the child safety seat is not simple, and thus the installation thereof inevitably takes a lot of time and labor, which causes inconvenience to the user.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a hidden-type automobile child safety seat assembly, whereby it does not take a lot of time and labor to install the child safety seat, and thus the convenience of usage is greatly enhanced.

For achieving the object described above, the present invention provides a hidden-type automobile child safety seat assembly, which has three types of safety seats respectively mounted in different portions of the rear bench of a car and includes: at least one first safety seat comprising a first seating portion and a first lap-belt, the first seating portion being pivotally connected to the bottom of the rear bench, the first lap-belt being fastened to the first seating portion; at least one second safety seat comprising a second seating portion, a protective bar and a second lap-belt, the second seating portion and the protective bar being pivotally connected to the back of the rear bench, the protective bar being located above the second seating portion, the second lap-belt being fastened in the back of the rear bench; and at least one third safety seat comprising a third seating portion and a third lap-belt, the third seating portion being pivotally connected to the back of the rear bench, the third lap-belt being fastened in the back of the rear bench.

The present invention has advantageous effects as follows. It is not necessary for an adult to spend time and labor to install the child safety seat. Further, each type of the safety seats is suitable for a child in a range of different ages. Therefore, it is very convenient to use this inventive child safety seat.

### BRIEF DESCRIPTION OF THE DRAWINGS

FIG. 1 is a perspective view showing the hidden-type automobile child safety seat assembly of the present invention;

FIG. 2 is a perspective view showing the first angle positioning unit of the present invention;

FIG. 3 is a perspective view showing the second angle positioning unit of the present invention;

FIG. 4 is a perspective view showing the first angle positioning unit of the present invention mounted to the rear end of the second seating portion;

FIG. 5 is a perspective view showing the first angle positioning unit of the present invention mounted to the front end of the second seating portion;

FIG. 6 is a perspective view showing the first angle positioning unit of the present invention mounted to the front end of the third seating portion;

FIG. 7 is a perspective view showing the second angle positioning unit of the present invention mounted to the first seating portion;

FIG. 8 is a perspective view showing the second angle positioning unit of the present invention mounted to the rear end of the third seating portion; and

FIG. 9 is a perspective view showing the second angle positioning unit of the present invention mounted to the protective bar.

### DETAILED DESCRIPTION OF THE PREFERRED EMBODIMENTS

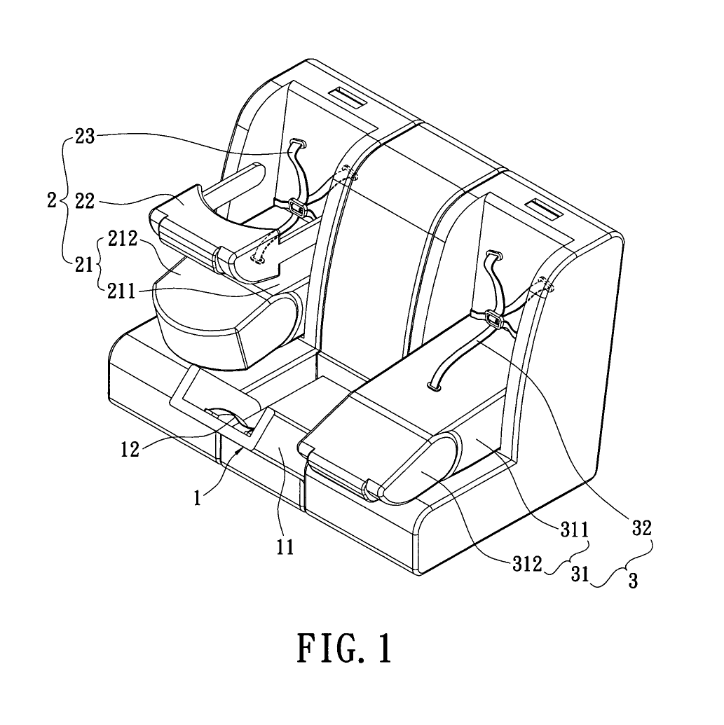

Please refer to FIG. 1. The present invention provides a hidden-type automobile child safety seat assembly, which has three types of child safety seats respectively mounted inside 3 portions of the rear bench of a passenger car and includes a first safety seat 1, a second safety seat 2 and a third safety seat 3. The first safety seat 1, the second safety seat 2 and the third safety seat 3 are mounted in different portions of the car rear bench. The first safety seat 1 comprises a first seating portion 11 and a first lap-belt 12. The first seating portion 11 is pivotally connected to the bottom of the rear bench, and the first lap-belt 12 is fastened to the inside of the first seating portion 11. The second safety seat 2 comprises a second seating portion 21, a protective bar 22 and a second lap-belt 23. The second seating portion 21 and the protective bar 22 are pivotally connected to the back of the rear bench. The protective bar 22 is located above the second seating portion 21, and the second lap-belt 23 is fastened in the back of the rear bench. After the second seating portion 21 and the protective bar 22 are put down, the back of the rear bench will form a recessed zone having an approximate depth of 12 cm. Thus, both side surfaces of the recessed zone in the back of the rear bench become left and right protective bars for protecting a child laterally. The third safety seat 3 comprises a third seating portion 31 and a third lap-belt 32. The third seating portion 31 is pivotally connected to the back of the rear bench, and the third lap-belt 32 is fastened in the back of the rear bench. After the third seating portion 31 is put down, the back of the rear bench also forms a recessed zone. As a result, both side surfaces of the recessed zone in the back of the rear bench become left and right protective bars for protecting a child laterally. The first safety seat 1, the second safety seat 2 and the third safety seat 3 are suitable for the children in the range of 1 age, 1-2 ages, and 2-4 ages respectively.

The second seating portion 21 comprises a first portion 211 and a second portion 212. The rear end of the second portion 212 is pivotally connected to the front end of the first portion 211, and the rear end of the first portion 211 is pivotally connected to the back of the rear bench. The third seating portion 31 comprises a third portion 311 and a fourth portion 312. The rear end of the fourth portion 312 is pivotally connected to the front end of the third portion 311, and the rear end of the third portion 311 is pivotally connected to the back of the rear bench.

Incidentally, in the hidden-type automobile child safety seat assembly of the present invention, the number of the first safety seat 1, the second safety seat 2 and the third safety seat 3 can be selected arbitrarily based on the demands of the user.

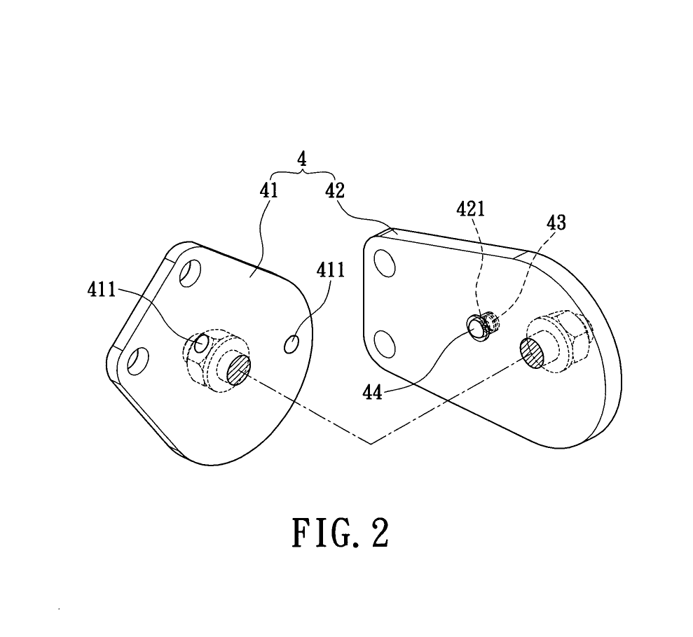

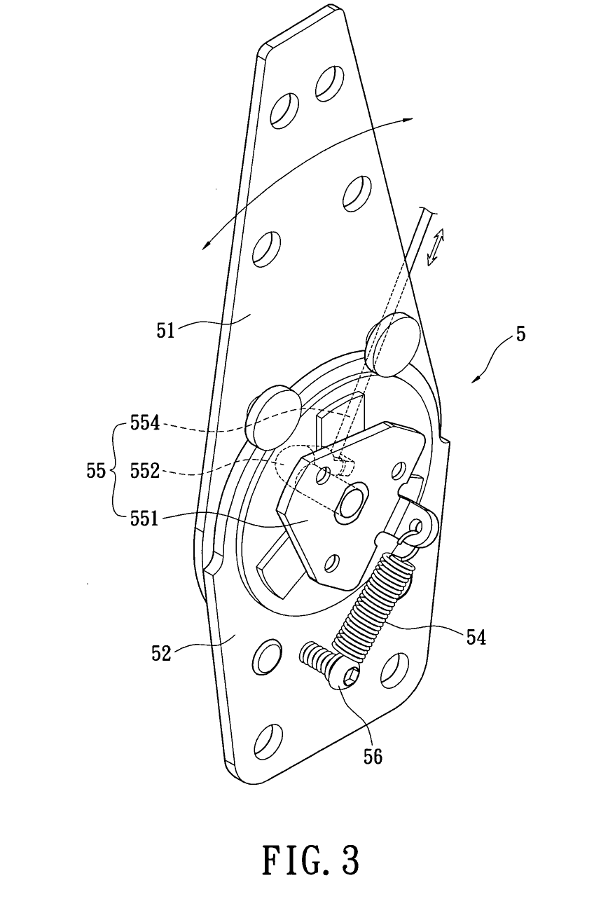

Further, a plurality of first angle positioning units 4 and second angle positioning units 5 (FIGS. 2 and 3) can be mounted on the first safety seat 1, the second safety seat 2 and the third safety seat 3, thereby positioning the angle of the first safety seat 1, the second safety seat 2 and the third safety seat 3 respectively.

As shown in FIG. 2, the first angle positioning unit 4 comprises a first movable piece 41, a first fixed piece 42, a first resilient element 43 and a bead 44. The first movable piece 41 is pivotally connected to one side of the first fixed piece 42, and the facing surfaces of the first movable piece 41 and the first fixed piece 42 are not brought into contact with each other, thereby avoiding from generating a large friction. The side of the first fixed piece 42 facing the first movable piece 41 is provided with a trough 421. The first resilient element 43 is a spring and is received in the trough 421. The two ends of the first resilient element 43 are fixed to the inner wall of the trough 421 and the bead 44 respectively. The opening of the trough 421 is slightly curved, thereby impeding the bead 44 from falling out of the trough 421. The side of the first movable piece 41 facing the first fixed piece 42 is provided with a plurality of bead positioning troughs 411 for allowing the bead 44 to be engaged in the bead positioning troughs 411. When the first movable piece 41 rotates, it applies a force to the bead 44 located in one bead positioning trough 411, thereby pushing the bead 44 to depart from the one bead positioning trough 411. After the first movable piece 41 rotates to a certain angle to make another bead positioning trough 411 to correspond to the bead 44, the rotation of the first movable piece 41 is stopped. Owing to the elastic force of the first resilient element 43, the bead 44 will be engaged in this new bead positioning trough 411, thereby positioning the angle of the first movable piece 41.

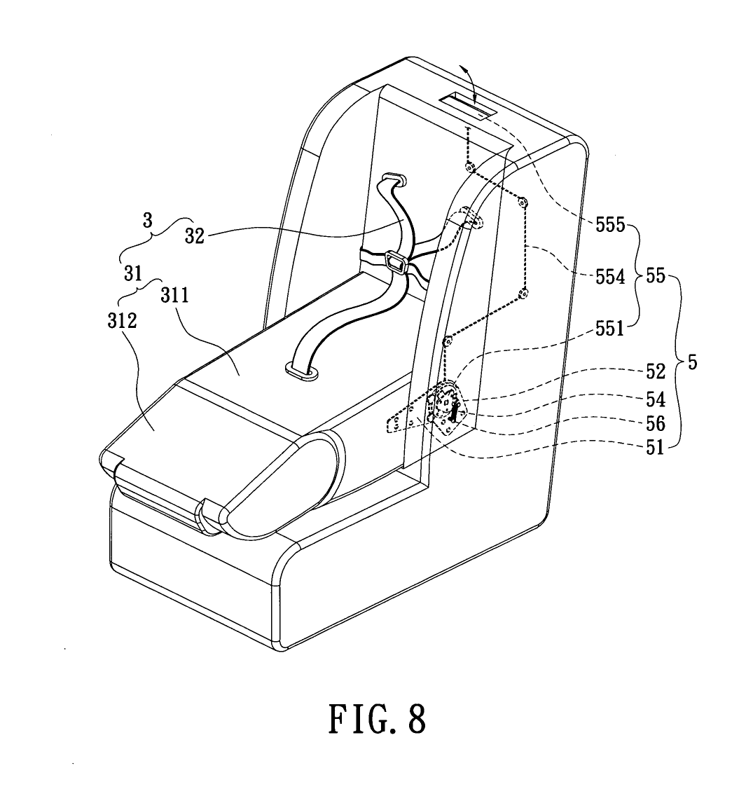

As shown in FIG. 3, the second angle positioning unit 5 comprises a second movable piece 51, a second fixed piece 52, a gear (not shown), a second resilient element 54 and a position controlling piece 55. The second movable piece 51 and the gear are pivotally connected to the second fixed piece 52. The gear is located between the second fixed piece 52 and the second movable piece 51. The position controlling piece 55 comprises a first connecting piece 551, a second connecting piece 552, an insert (not shown), a driving piece 554 and a handle 555 (FIG. 8). The first connecting piece 551 is pivotally connected to the second fixed piece 52. One end of the second connecting piece 552 is fixed to the first connecting piece 551, and the other end of the second connecting piece 552 extends outside the second movable piece 51 with a curved extending portion. The insert is fixed to the first connecting piece 551. The insert can be engaged with the teeth of the gear, thereby blocking the rotation of the gear and the second movable piece 51. The outside of the second fixed piece 52 is provided with a fixing pin 56. The second resilient element 54 is torsion spring. One end of the second resilient element 54 is hooked to the fixing pin 56, and the other end thereof is hooked to the first connecting piece 551. One end of the driving piece 554 is fixed to the portion of the second connecting piece 552 extending outside the second movable piece 51, and the other end thereof is fixed to the handle 555. When the user holds the handle 555 and lift it up, the handle 555 pulls the driving piece 554, and in turn the driving piece 554 drives the second connecting piece 552, the first connecting piece 551 and the insert to move. As a result, the insert will be disengaged from the teeth of the gear, and thus the gear and the second movable piece 51 can rotate at this time. Further, the movement of the first connecting piece 551 will tension the second resilient element 54. Since the portion of the second connecting piece 552 extending outside the second movable piece 51 is slightly curved, the user can pull the handle 555 with less labor due to the lever principle. When the user releases the handle 555, the first connecting piece 551 will return to its original position due to the elastic force of the second resilient element 54, thereby causing the insert to be engaged with the teeth of the gear again. Via the elastic force of the second resilient element 54, the insert can be engaged with the gear firmly. As a result, the gear and the second movable piece 51 cannot rotate at this time, thereby positioning the angle of the second movable piece 51.

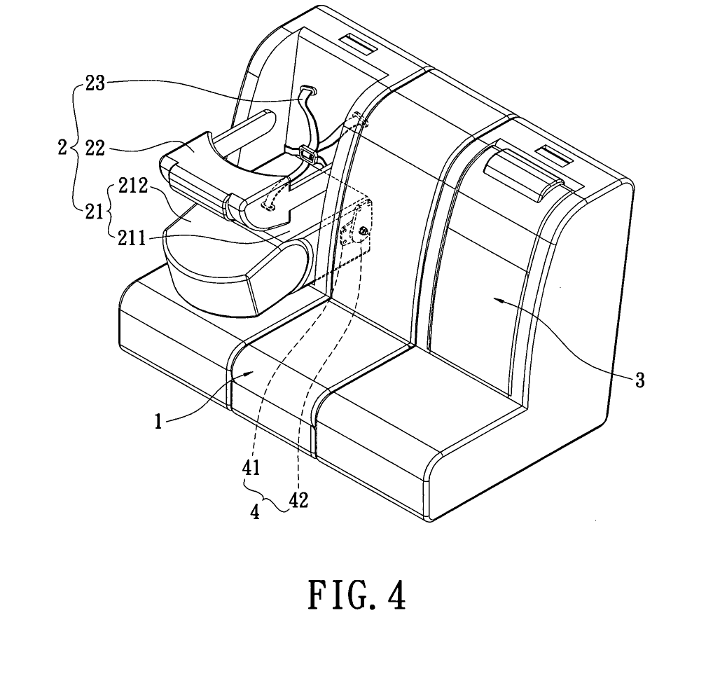

As shown in FIG. 4, there are three sets of the first angle positioning units 4. The first set of first angle positioning unit 4 is mounted to the second seating portion 21, in which the first movable piece 41 is fixed to the rear end of the first portion 211, and the first fixed piece 42 is fixed in the back of the rear bench.

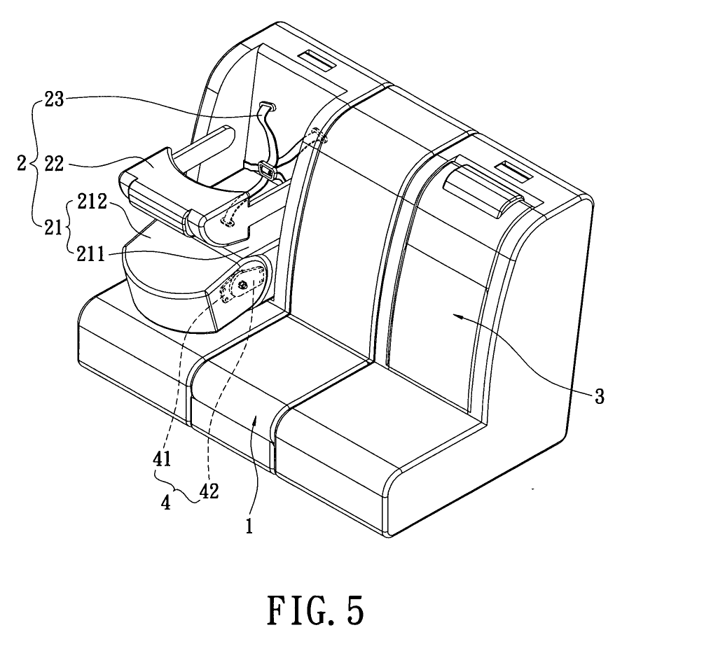

As shown in FIG. 5, the second set of the first angle positioning unit 4 is mounted to the second seating portion 21, in which the rear end of the second portion 212 is fixed to the first movable piece 41, and the front end of the first portion 211 is fixed to the first fixed piece 42.

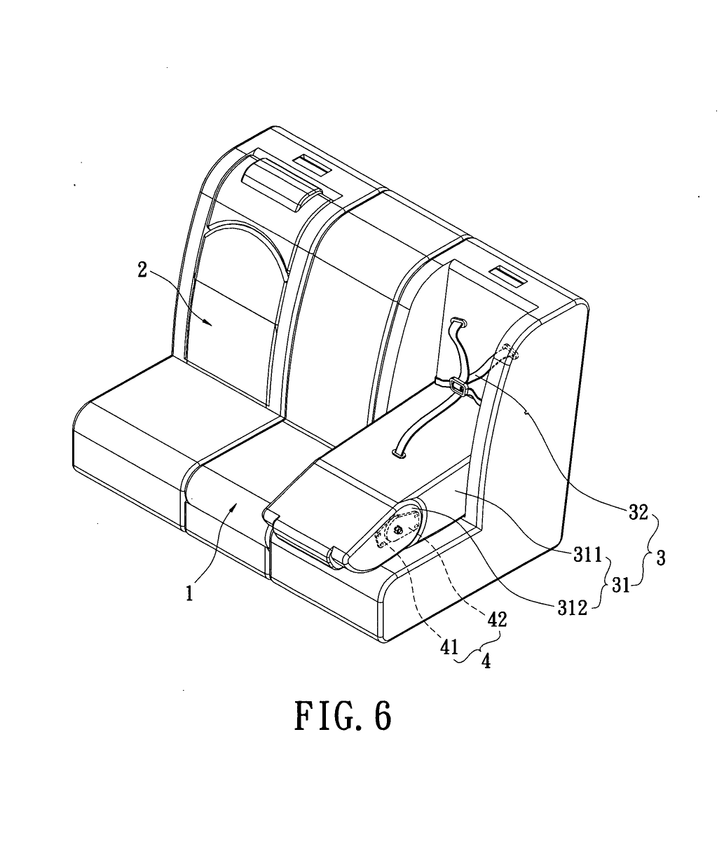

As shown in FIG. 6, the third set of the first angle positioning unit 4 is mounted to the third seating portion 31, in which the first movable piece 41 is fixed to the rear end of the fourth portion 312, and the first fixed piece 42 is fixed to the front end of the third portion 311.

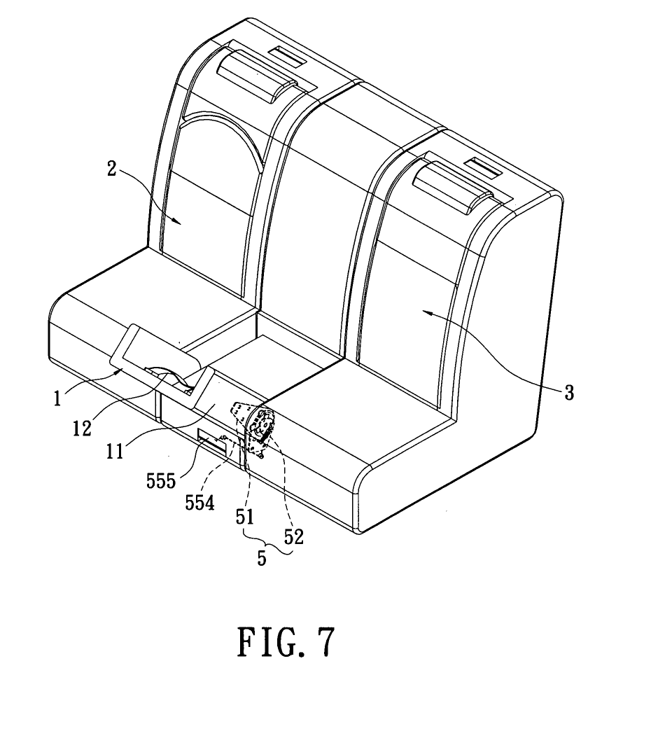

As shown in FIG. 7, there are three sets of the second angle positioning units 5. The first set of second angle positioning unit 5 is mounted to the first safety seat 1, in which the second movable piece 51 is fixed to the first seating portion 11, and the second fixed piece 52 is fixed in the rear bench. The handle 555 is mounted to a lower right portion of the rear bench, thereby facilitating the operation of the user.

As shown in FIG. 8, the second set of the second angle positioning unit 5 is mounted to the third seating portion 31, in which the second movable piece 51 is fixed to the rear end of the third portion 311, and the second fixed piece 52 is fixed in the back of the rear bench.

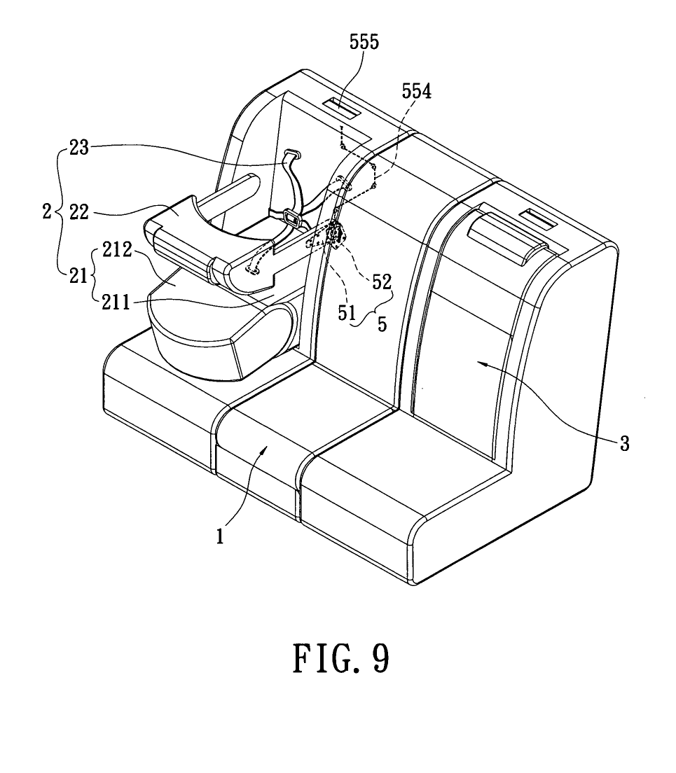

As shown in FIG. 9, the third set of the second angle positioning unit 5 is mounted to the protective bar 22, in which the second movable piece 51 is fixed to the rear end of the protective bar 22, and the second fixed piece 52 is fixed in the back of the rear bench.

The hidden-type automobile child safety seat assembly of the present invention has advantageous effects as follows.

(1) It is not necessary for an adult to spend time and labor to install the child safety seat. Further, each type of the safety seats 1, 2, 3 is suitable for a child in a range of different ages. Therefore, it is very convenient to use this inventive child safety seat.

(2) Via the first angle positioning unit 4 and the second angle positioning unit 5, the angle of the safety seats 1, 2, 3 can be adjusted properly according to the size and comfortable feeling of the child. With this arrangement, the safety seats 1, 2, 3 can be prevented from being turned over due to the shake of the moving car.

(3) After the second seating portion 21 and the protective bar 22 are put down, the back of the rear bench will form a recessed zone having an approximate depth of 12 cm. Thus, both side surfaces of the recessed zone in the back of the rear bench become left and right protective bars for protecting a child laterally.

(4) After the third seating portion 31 is put down, the back of the rear bench will form a recessed zone. Thus, both side surfaces of the recessed zone in the back of the rear bench become left and right protective bars for protecting a child laterally.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hidden-type automobile child safety seat assembly, having three types of safety seats respectively mounted inside 3 portions of a rear bench of a passenger car and comprising:
at least one first safety seat comprising a first seating portion and a first lap-belt, the first seating portion being pivotally connected to the bottom of the rear bench, the first lap-belt being fastened to the first seating portion;
at least one second safety seat comprising a second seating portion, a protective bar and a second lap-belt, the second seating portion and the protective bar being pivotally connected to the back of the rear bench, the protective bar being located above the second seating portion, the second lap-belt being fastened in the back of the rear bench; and
at least one third safety seat comprising a third seating portion and a third lap-belt, the third seating portion, and being pivotally connected to the back of the rear bench, the third lap-belt being fastened in the back of the rear bench.

2. The hidden-type automobile child safety seat assembly according to claim 1, wherein the second seating portion comprises a first portion and a second portion each having a front end and a rear end, the rear end of the second portion being pivotally connected to the front end of the first portion, the rear end of the first portion being pivotally connected to the back of the rear bench.

3. The hidden-type automobile child safety seat assembly according to claim 1, wherein the third seating portion comprises a third portion and a fourth portion each having a front end and a rear end, the rear end of the fourth portion being pivotally connected to the front end of the third portion, the rear end of the third portion being pivotally connected to the back of the rear bench.

4. The hidden-type automobile child safety seat assembly according to claim 1, further comprising a plurality of first angle positioning units each comprising a first movable piece, a first fixed piece, a first resilient element and a bead, the first movable piece being pivotally connected to the first fixed piece, the first fixed piece being provided with a trough, the first resilient element being received in the trough, both ends of the first resilient element being fixed to an inner wall of the trough and the bead respectively, the first movable piece being provided with a plurality of bead positioning troughs, the bead being engaging in the bead positioning trough.

5. The hidden-type automobile child safety seat assembly according to claim 4, wherein the second seating portion comprises a first portion and a second portion each having a front end and a rear end, the rear end of the second portion being pivotally connected to the front end of the first portion, the rear end of the first portion being pivotally connected to the back of the rear bench, the first movable piece being fixed to the rear end of the first portion, the first fixed piece is fixed in the back of the rear bench.

6. The hidden-type automobile child safety seat assembly according to claim 5, wherein the rear end of the second portion is fixed to another first movable piece, a front end of the first portion is fixed to another first fixed piece.

7. The hidden-type automobile child safety seat assembly according to claim 4, wherein the third seating portion comprises a third portion and a fourth portion each having a front end and a rear end, the rear end of the fourth portion is pivotally connected to the front end of the third portion, the rear end of the third portion is pivotally connected to the back of the rear bench, the first movable piece is fixed to the rear end of the fourth portion, the first fixed piece is fixed to the front end of the third portion.

8. The hidden-type automobile child safety seat assembly according to claim 1, further comprising a plurality of angle positioning units each comprising a second movable piece, a second fixed piece, a gear, a second resilient element and a position controlling piece, the second movable piece and the gear being pivotally connected to the second fixed piece, the gear being located between the second fixed piece and the second movable piece, whereby the position controlling piece comprises a first connecting piece, a second connecting piece, an insert, a driving piece and a handle, the first connecting piece being pivotally connected to the second fixed piece, one end of the second connecting piece being fixed to the first connecting piece, the insert being fixed to the first connecting piece, the insert being engaged in teeth of the gear, the outside of the second fixed piece being provided with a fixing pin, both ends of the second resilient pieces being fixed to the fixing pin and the first connecting piece respectively, both ends of the driving piece being fixed to the other end of the second connecting piece and the handle respectively.

9. The hidden-type automobile child safety seat assembly according to claim 8, wherein the second movable piece is fixed to the first seating portion, and the second fixed piece is fixed in the rear bench.

10. The hidden-type automobile child safety seat assembly according to claim 8, wherein the second movable piece is fixed to a rear end of the protective bar, and the second fixed piece is fixed in the back of the rear bench.

11. The hidden-type automobile child safety seat assembly according to claim 8, wherein the second movable piece is fixed to the third portion of the third seating portion, and the second fixed piece is fixed in the back of the rear bench.
